(19) United States
(12) Patent Application Publication
(10) Pub. No.: US 2017/0168771 A1
(43) Pub. Date: Jun. 15, 2017

(54) SONG PLAYING PROGRESS CONTROL METHOD AND ELECTRONIC DEVICE

(71) Applicants: Le Holdings (Beijing) Co., Ltd., Beijing (CN); Le Shi Internet Information & Technology Corp., Beijing, Beijing (CN)

(72) Inventors: Yu Zhao, Beijing (CN); Shibin Li, Beijing (CN); Jianwei Guo, Beijing (CN); Xiaolei Niu, Beijing (CN); Ruotao Wang, Beijing (CN)

(73) Assignees: Le Holdings (Beijing) Co., Ltd., Beijing (CN); Le Shi Internet Information & Technology Corp., Beijing, Beijing (CN)

(21) Appl. No.: 15/243,943

(22) Filed: Aug. 22, 2016

Related U.S. Application Data
(63) Continuation of application No. PCT/CN2016/088317, filed on Jul. 4, 2016.

(30) Foreign Application Priority Data
Dec. 11, 2015 (CN) 201510920198.X

(51) Int. Cl. G06F 3/16; G06F 3/0488; G06F 3/0484

(52) U.S. Cl. CPC G06F 3/165; G06F 3/04847; G06F 3/0488

(57) ABSTRACT

Disclosed are a song playing progress control method and an electronic device, wherein, the method includes the following steps: detecting whether a touch operation occurs on a current playing progress bar; if a touch operation occurs on a current playing progress bar, determining the types of the touch operation, including click touch and slide; if the type of the touch operation is click touch, determining whether the time of the touch operation is less than a preset time threshold value; if the time of the touch operation is less than a preset time threshold value, switching to a time point corresponding to the position where the touch operation is located to conduct playing; otherwise, detecting and determining whether the strength of the touch operation is less than a preset strength threshold value; if the strength of the touch operation is less than a preset strength threshold value, previewing the lyrics at the time point corresponding to the position where the touch operation is located; otherwise, switching to display the lyrics at the time point corresponding to the position where the touch operation is located.

### CROSS REFERENCE TO RELATED APPLICATIONS

This application is a continuation of International Application No. PCT/CN2016/088317, filed on Jul. 4, 2016, which is based upon and claims priority to Chinese Patent Application No. 201510920198.x, filed on Dec. 11, 2015, the entire contents of which are incorporated herein by reference.

### TECHNICAL FIELD

The disclosure relates to the field of intelligent terminals, and particularly relates to a song playing progress control method and an electronic device.

### BACKGROUND

In the prior arts, Apple Inc. released the touch control technology of 3D Touch in 2015 Autumn New Product Release Conference. The perception to strength and finger area is added in the 3D-Touch technology, as compared with the operation of the multi-touch technology in a two-dimensional planar space, and the click strength can be divided into light click, light press and heavy press, thereby realizing different operations. This touch control technology is well applied to mobile equipment having a large screen size. The movement of a finger is inconvenient due to the overlarge screen size, while the number of times of movement of the finger can be reduced by applying two kinds of gravity operations to the same region, thereby improving the use efficiency.

When a user uses the mobile equipment to play a song with a music application, one common use scenario is to switch a song progress bar, such as skipping a prelude, only listening to a climax, etc. At present, the music application in a mobile terminal generally has two methods for switching progress:

(1) dragging a progress bar by long-time press to realize progress switching, which has the disadvantage that the progress switching is inaccurate because the user can only see the progress time but does not know the current playing content during dragging;

(2) firstly, dragging a lyric page, and then clicking “play from the current position”, which has the disadvantage that it is not convenient enough to complete switching because there is need of two steps of operations and a finger needs to move.

### SUMMARY

The present disclosure discloses a song playing progress control method and an electronic device for solving the technical problem that an existing intelligent terminal having a touch control screen is not convenient enough in the operation of song playing progress and is difficult to accurately conduct progress switching.

Thus, the embodiments of the present disclosure provide the following technical solutions:

The present disclosure provides a song playing progress control method, including the following steps: detecting whether a touch operation occurs on a current playing progress bar; if a touch operation occurs on a current playing progress bar, determining the types of the touch operation, the operation types including click touch and slide; if the operation type is click touch, determining whether the time of the touch operation is less than a preset time threshold value; if the time of the touch operation is less than a preset time threshold value, switching to a time point corresponding to the position where the touch operation is located to conduct playing; otherwise, detecting and determining whether the strength of the touch operation is less than a preset strength threshold value; if the strength of the touch operation is less than a preset strength threshold value, previewing the lyrics at the time point corresponding to the position where the touch operation is located; otherwise, switching to display the lyrics at the time point corresponding to the position where the touch operation is located.

Another objective of the embodiments of the present disclosure is to provide an electronic device, including at least one processor; and a memory communicably connected with the at least one processor for storing instructions executable by the at least one processor, wherein execution of the instructions by the at least one processor causes the at least one processor to: detect whether a touch operation occurs on a current playing progress bar; if a touch operation occurs on a current playing progress bar, determine the types of the touch operation, the operation types including click touch and slide; if the operation type is click touch, determine whether the time of the touch operation is less than a preset time threshold value; if the time of the touch operation is less than a preset time threshold value, switch to a time point corresponding to the position where the touch operation is located to conduct playing; otherwise, detect and determine whether the strength of the touch operation is less than a preset strength threshold value; if the strength of the touch operation is less than a preset strength threshold value, preview the lyrics at the time point corresponding to the position where the touch operation is located; otherwise, switch to display the lyrics at the time point corresponding to the position where the touch operation is located.

A further objective of the embodiments of the present disclosure is to provide a non-transitory computer-readable storage medium storing executable instructions that, when executed by an electronic device, cause the electronic device to: detect whether a touch operation occurs on a current playing progress bar; if a touch operation occurs on a current playing progress bar, determine the types of the touch operation, the operation types including click touch and slide; if the operation type is click touch, determine whether the time of the touch operation is less than a preset time threshold value; if the time of the touch operation is less than a preset time threshold value, switch to a time point corresponding to the position where the touch operation is located to conduct playing; otherwise, detect and determine whether the strength of the touch operation is less than a preset strength threshold value; if the strength of the touch operation is less than a preset strength threshold value, preview the lyrics at the time point corresponding to the position where the touch operation is located; otherwise, switch to display the lyrics at the time point corresponding to the position where the touch operation is located.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of a song playing progress control method in accordance with embodiment 1 of the present disclosure;

FIG. 2 is a schematic block diagram of a song playing progress control electronic device in accordance with embodiment 2 of the present disclosure; and

FIG. 3 is a schematic diagram of hardware configuration of an electronic device in accordance with the embodiments of the present disclosure.

### DETAILED DESCRIPTION

In order to clearly describe objectives, the technical solutions and advantages of the present disclosure. A clear and complete description of the technical solutions in the present disclosure will be given below, in conjunction with the accompanying drawings in the embodiments of the present disclosure. Apparently, the embodiments described below are a part, but not all, of the embodiments of the present disclosure.

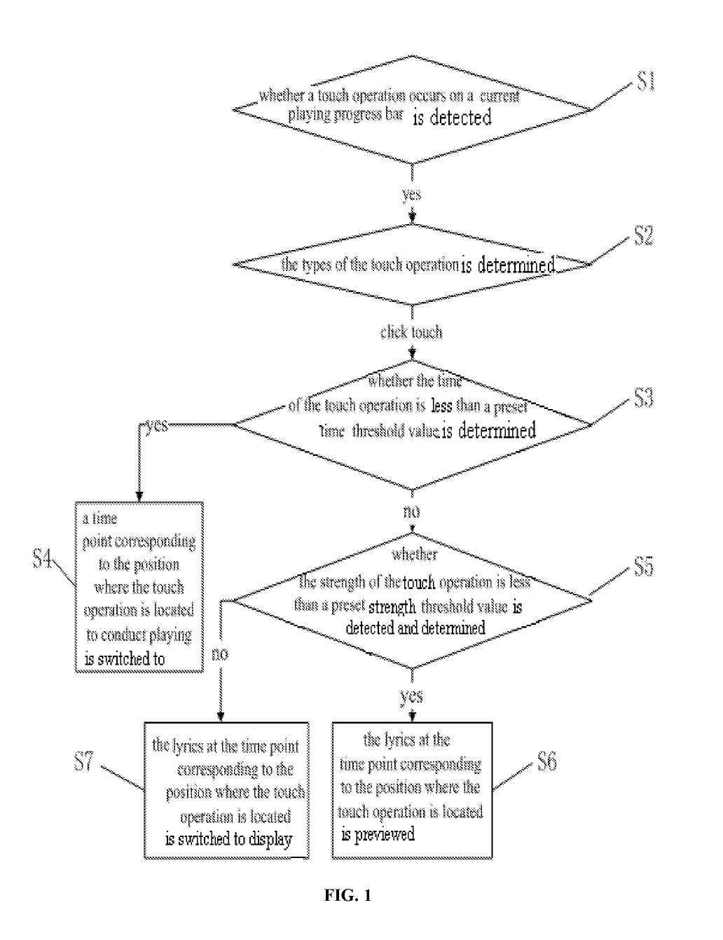

This embodiment provides a song playing progress control method, which is applied to an intelligent mobile terminal held by a user. As shown in FIG. 1, the method includes the following steps:

S1: whether a touch operation occurs on a current playing progress bar is detected;

S2: if a touch operation occurs on a current playing progress bar, the types of the touch operation, including click touch and slide is determined, wherein generally, there are only such two operation types, but the slide operation itself has many types;

S3: if the type of the touch operation is click touch, whether the time of the touch operation is less than a preset time threshold value is determined, wherein the time threshold value here can be set to 2 seconds, or can be set to other time values of course according to the use habits of the user;

S4: if the time of the touch operation is less than the preset time threshold value, a time point corresponding to the position where the touch operation is located to conduct playing is switched to , wherein if the time of the touch operation is less than the preset time threshold value, the click touch operation is generally considered as light touch;

S5: if the time of the touch operation is not less than the preset time threshold value, whether the strength of the touch operation is less than a preset strength threshold value is determined, wherein the strength threshold value is set as required;

S6: if the strength of the touch operation is less than the preset strength threshold value, the lyrics at the time point corresponding to the position where the touch operation is located is previewed, wherein if the time of the click touch is not less than the preset time threshold value and the strength is less than the preset strength threshold value, the click touch operation is considered as light press; and

S7: if the strength of the touch operation is not less than the preset strength threshold value, the lyrics at the time point corresponding to the position where the touch operation is located is switched to display, wherein if the time of the click touch is not less than the preset time threshold value and the strength is not less than the preset strength threshold value, the click touch operation is considered as heavy press.

By means of the song playing progress control method provided by this embodiment, the user can conduct the switching of song playing progress and the switching of corresponding lyric display only by a single-touch control operation. Moreover, the switching position is accurate, and the position can be switched as required; there is no need of multiple operations, and there is also no need of multiple adjustments; and the operation is convenient. Especially, for an intelligent terminal having a larger touch control screen, the number of times of movements and the movement distance which are required during operation are greatly reduced, and the controllability is improved, thereby greatly improving the user experience.

As another embodiment, the above-mentioned method further includes:

S8: if the touch operation is slide, whether the strength of the touch operation is less than a preset strength threshold value is determined;

S9: if the strength of the touch operation is less than a preset strength threshold value, the direction of the touch operation is detected;

S10: if it is detected that the direction of the touch operation is forward, fast forward once in accordance with a first preset time period is conducted; and

S11: if it is detected that the direction of the touch operation is backward, fast backward once in accordance with the first preset time period is conducted.

As yet another embodiment, the method further includes:

S12: if the strength of the touch operation is not less than the preset strength threshold value, the direction of the touch operation is detected;

S13: if it is detected that the direction of the touch operation is forward, fast forward once in accordance with a second preset time period is conducted, wherein the second preset time period is greater than the first preset time period, and the second preset time period is 5 to 10 times as long as the first preset time period, for example, the first preset time period is 2 seconds, and the second preset time period is 10 seconds, that is, lightly sliding forwards (generally rightwards) on a progress bar means fast forward by 2 seconds, lightly sliding backwards (generally leftwards) on the progress bar means fast backward by 2 seconds, heavily sliding forwards (generally rightwards) on the progress bar means fast forward by 10 seconds, and heavily sliding backwards (generally leftwards) on the progress bar means fast backward by 10 seconds, so that the playing progress can be controlled relatively accurately; and

S14: if it is detected that the direction of the touch operation is backward, fast backward once in accordance with the second preset time period is conducted.

By means of the above-mentioned song playing progress control method, the time of every fast forward or fast backward is determined according to the strength of the slide operation on the progress bar, and the time of each operation is definite, so that the progress of fast forward can be controlled accurately.

As yet another embodiment, the method further includes:

a time anchor point on the progress bar to switch playing progress is dragged.

As shown in FIG. 2, this embodiment provides a song playing progress control device, including: a touch operation detection unit U1 for detecting whether a touch operation occurs on a current playing progress bar; a type determination unit U2 for determining the types of the touch operation, including click touch and slide, if the touch operation occurs; a first time determination unit U3 for determining whether the time of the touch operation is less than a preset time threshold value if the type of the touch operation is click touch; a switching unit U4 for switching to a time point corresponding to the position where the touch operation is located to conduct playing if the time of the touch operation is less than the preset time threshold value; a first strength determination unit U5 for detecting and determining whether the strength of the touch operation is less than a preset strength threshold value if the time of the touch operation is not less than the preset time threshold value; a lyric preview unit U6 for previewing the lyrics at the time point corresponding to the position where the touch operation is located if the strength is less than the preset strength threshold value; and a lyric switching unit U7 for switching to display the lyrics at the time point corresponding to the position where the touch operation is located if the strength is not less than the preset strength threshold value.

By means of the song playing progress control method provided by this embodiment, the user can conduct the switching of song playing progress and the switching of corresponding lyric display only by a single-touch control operation. Moreover, the switching position is accurate, and the position can be switched as required; there is no need of multiple operations, and there is also no need of multiple adjustments; and the operation is convenient, thereby improving the user experience.

Specifically, the device further includes: a second strength determination unit for determining whether the strength of the touch operation is less than the preset strength threshold value if the touch operation is slide; a first direction detection unit for detecting the direction of the touch operation if the strength of the touch operation is less than the preset strength threshold value; a first fast-forward unit for conducting fast forward once in accordance with a first preset time period if it is detected that the direction of the touch operation is forward; and a first fast-backward unit for conducting fast backward once in accordance with the first preset time period if it is detected that the direction of the touch operation is backward.

Specifically, the device further includes: a second direction detection unit for detecting the direction of the touch operation if the strength of the touch operation is not less than the preset strength threshold value when the touch operation is slide; a second fast-forward unit for conducting fast forward once in accordance with a second preset time period if it is detected that the direction of the touch operation is forward, wherein the second preset time period is greater than the first preset time period; and a second fast-backward unit for conducting fast backward once in accordance with the second preset time period if it is detected that the direction of the touch operation is backward.

By means of the above-mentioned device, the time of every fast forward or fast backward is determined according to the strength of the slide operation on the progress bar, and the time of each operation is definite, so that the progress of fast forward can be controlled accurately.

Specifically, the device further includes: a drag switching unit for dragging a time anchor point on the progress bar to switch playing progress.

The embodiments of the present disclosure provide a non-transitory computer-readable storage medium storing executable instructions that, when executed by an electronic device, cause the electronic device to: detect whether a touch operation occurs on a current playing progress bar; if a touch operation occurs on a current playing progress bar, determine the types of the touch operation, the operation types including click touch and slide; if the operation type is click touch, determine whether the time of the touch operation is less than a preset time threshold value; if the time of the touch operation is less than a preset time threshold value, switch to a time point corresponding to the position where the touch operation is located to conduct playing; otherwise, detect and determine whether the strength of the touch operation is less than a preset strength threshold value; if the strength of the touch operation is less than a preset strength threshold value, preview the lyrics at the time point corresponding to the position where the touch operation is located; otherwise, switch to display the lyrics at the time point corresponding to the position where the touch operation is located.

As an alternative embodiment, the non-transitory computer-readable storage medium further includes: if the touch operation is slide, whether the strength of the touch operation is less than a preset strength threshold value is determining; if the strength of the touch operation is less than a preset strength threshold value, detecting the direction of the touch operation; if it is detected that the direction of the touch operation is forward, conducting fast forward once in accordance with a first preset time period; and if it is detected that the direction of the touch operation is backward, conducting fast backward once in accordance with the first preset time period.

As an alternative embodiment, the non-transitory computer-readable storage medium further includes: when the touch operation is slide, if the strength of the touch operation is not less than the preset strength threshold value, the direction of the touch operation is detected; if it is detected that the direction of the touch operation is forward, fast forward once in accordance with a second preset time period is conducted, wherein the second preset time period is greater than the first preset time period; and if it is detected that the direction of the touch operation is backward, fast backward once in accordance with the second preset time period is conducted.

As an alternative embodiment, the second preset time period is 5 to 10 times as long as the first preset time period.

As an alternative embodiment, the non-transitory computer-readable storage medium further includes: a time anchor point on the progress bar to switch playing progress is dragged.

### Embodiment 4

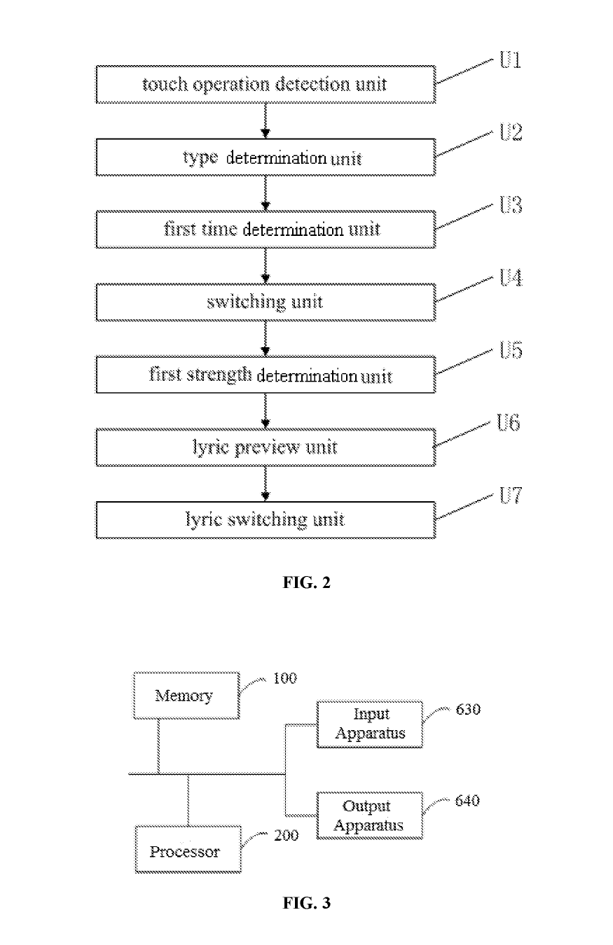

FIG. 3 is a schematic diagram of the hardware configuration of the electronic device provided by the embodiment, which performs the song playing progress control method. As shown in FIG. 3, the electronic device includes: one or more processors 100 and a memory 200, wherein one processor 100 is shown in FIG. 3 as an example. The electronic device that performs the song playing progress control method further includes an input apparatus 630 and an output apparatus 640.

The processor 100, the memory 200, the input apparatus 630 and the output apparatus 640 may be connected via a bus line or other means, wherein connection via a bus line is shown in FIG. 3 as an example.

The memory 200 is a non-transitory computer-readable storage medium that can be used to store non-transitory software programs, non-transitory computer-executable programs and modules, such as the program instructions/modules corresponding to the song playing progress control method of the embodiments of the present disclosure (e.g. touch operation detection unit U1, type determination unit U2, first time determination unit U3, switching unit U4, first strength determination unit U5, lyric preview unit U6 and lyric switching unit U7 shown in the FIG. 2). The processor 100 executes the non-transitory software programs, instructions and modules stored in the memory 200 so as to perform various function application and data processing of the server, thereby implementing the song playing progress control method of the above-mentioned method embodiments.

The memory 200 includes a program storage area and a data storage area, wherein, the program storage area can store an operation system and application programs required for at least one function; the data storage area can store data generated by use of the song playing progress control device. Furthermore, the memory 200 may include a high-speed random access memory, and may also include a non-volatile memory, e.g. at least one magnetic disk memory unit, flash memory unit, or other non-volatile solid-state memory unit. In some embodiments, optionally, the memory 200 includes a remote memory accessed by the processor 100, and the remote memory is connected to the song playing progress control device via network connection. Examples of the aforementioned network include but not limited to internet, intranet, LAN, GSM, and their combinations.

The input apparatus 630 receives digit or character information, so as to generate signal input related to the user configuration and function control of the song playing progress control device. The output apparatus 640 includes display devices such as a display screen.

The one or more modules are stored in the memory 200 and, when executed by the one or more processors 100, perform the song playing progress control method of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

What is claimed is:

1. A song playing progress control method, comprising:
detecting whether a touch operation occurs on a current playing progress bar;
if a touch operation occurs on a current playing progress bar, determining the types of the touch operation, wherein the operation types comprises click touch and slide;
if the operation type is click touch, determining whether the time of the touch operation is less than a preset time threshold value; if the time of the touch operation is less than a preset time threshold value, switching to a time point corresponding to the position where the touch operation is located to conduct playing;
if the time of the touch operation is not less than a preset time threshold value, detecting and determining whether the strength of the touch operation is less than a preset strength threshold value; if the strength of the touch operation is less than a preset strength threshold value, previewing the lyrics at the time point corresponding to the position where the touch operation is located;
if the strength of the touch operation is not less than a preset strength threshold value, switching to display the lyrics at the time point corresponding to the position where the touch operation is located.

2. The method of claim 1, further comprising:
if the touch operation is slide, determining whether the strength of the touch operation is less than a preset strength threshold value;
if the strength of the touch operation is less than a preset strength threshold value, detecting the direction of the touch operation;
if it is detected that the direction of the touch operation is forward, conducting fast forward once in accordance with a first preset time period; and
if it is detected that the direction of the touch operation is backward, conducting fast backward once in accordance with the first preset time period.

3. The method of claim 2, further comprising:
when the touch operation is slide, if the strength of the touch operation is not less than the preset strength threshold value, detecting the direction of the touch operation;
if it is detected that the direction of the touch operation is forward, conducting fast forward once in accordance with a second preset time period, wherein the second preset time period is greater than the first preset time period; and
if it is detected that the direction of the touch operation is backward, conducting fast backward once in accordance with the second preset time period.

4. The method of claim 3, wherein, the second preset time period is 5 to 10 times as long as the first preset time period.

5. The method of claim 1, further comprising:
dragging a time anchor point on the progress bar to switch playing progress.

6. An electronic device, comprising:
at least one processor; and
a memory communicably connected with the at least one processor for storing instructions executable by the at least one processor, wherein execution of the instructions by the at least one processor causes the at least one processor to:
detect whether a touch operation occurs on a current playing progress bar;
if a touch operation occurs on a current playing progress bar, determine the types of the touch operation, the operation types including click touch and slide;
if the operation type is click touch, determine whether the time of the touch operation is less than a preset time threshold value; if the time of the touch operation is less than a preset time threshold value, switch to a time point corresponding to the position where the touch operation is located to conduct playing;
otherwise, detect and determine whether the strength of the touch operation is less than a preset strength threshold value; if the strength of the touch operation is less than a preset strength threshold value, preview the lyrics at the time point corresponding to the position where the touch operation is located;
otherwise, switch to display the lyrics at the time point corresponding to the position where the touch operation is located.

7. The electronic device of claim 6, wherein, the at least one processor is further caused to:
if the touch operation is slide, determine whether the strength of the touch operation is less than a preset strength threshold value;
if the strength of the touch operation is less than a preset strength threshold value, detect the direction of the touch operation;
if it is detected that the direction of the touch operation is forward, conduct fast forward once in accordance with a first preset time period; and
if it is detected that the direction of the touch operation is backward, conduct fast backward once in accordance with the first preset time period.

8. The electronic device of claim 7, wherein, the at least one processor is further caused to:
when the touch operation is slide, if the strength of the touch operation is not less than the preset strength threshold value, detect the direction of the touch operation;
if it is detected that the direction of the touch operation is forward, conduct fast forward once in accordance with a second preset time period, wherein the second preset time period is greater than the first preset time period; and
if it is detected that the direction of the touch operation is backward, conduct fast backward once in accordance with the second preset time period.

9. The electronic device of claim 8, wherein, the second preset time period is 5 to 10 times as long as the first preset time period.

10. The electronic device of claim 6, wherein, the at least one processor is further caused to:
drag a time anchor point on the progress bar to switch playing progress.

11. A non-transitory computer-readable storage medium storing executable instructions that, when executed by an electronic device, cause the electronic device to:
detect whether a touch operation occurs on a current playing progress bar;
if a touch operation occurs on a current playing progress bar, determine the types of the touch operation, the operation types including click touch and slide;
if the operation type is click touch, determine whether the time of the touch operation is less than a preset time threshold value; if the time of the touch operation is less than a preset time threshold value, switch to a time point corresponding to the position where the touch operation is located to conduct playing;
otherwise, detect and determine whether the strength of the touch operation is less than a preset strength threshold value; if the strength of the touch operation is less than a preset strength threshold value, preview the lyrics at the time point corresponding to the position where the touch operation is located;
otherwise, switch to display the lyrics at the time point corresponding to the position where the touch operation is located.

12. The non-transitory computer-readable storage medium of claim 11, wherein, the executable instructions further cause the electronic device to:
if the touch operation is slide, determine whether the strength of the touch operation is less than a preset strength threshold value;
if the strength of the touch operation is less than a preset strength threshold value, detect the direction of the touch operation;
if it is detected that the direction of the touch operation is forward, conduct fast forward once in accordance with a first preset time period; and
if it is detected that the direction of the touch operation is backward, conduct fast backward once in accordance with the first preset time period.

13. The non-transitory computer-readable storage medium of claim 12, wherein, the executable instructions further cause the electronic device to:
when the touch operation is slide, if the strength of the touch operation is not less than the preset strength threshold value, detect the direction of the touch operation;
if it is detected that the direction of the touch operation is forward, conduct fast forward once in accordance with a second preset time period, wherein the second preset time period is greater than the first preset time period; and
if it is detected that the direction of the touch operation is backward, conduct fast backward once in accordance with the second preset time period.

14. The non-transitory computer-readable storage medium of claim 13, wherein, the second preset time period is 5 to 10 times as long as the first preset time period.

15. The non-transitory computer-readable storage medium of claim 11, wherein, the executable instructions further cause the electronic device to:
drag a time anchor point on the progress bar to switch playing progress.
